(19) United States
(12) Patent Application Publication
(10) Pub. No.: US 2005/0046885 A1
(43) Pub. Date: Mar. 3, 2005

(54) Image structure reproduction quality creating method, image structure reproduction quality creating apparatus, and image structure reproduction quality creating program storage medium

(75) Inventor: Seiichiro Morikawa, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/928,149

(22) Filed: Aug. 30, 2004

(30) Foreign Application Priority Data
Sep. 1, 2003 (JP) 2003-308483

(51) Int. Cl. H04N 1/40; H04N 1/409; H04N 1/56; H04N 1/58

(52) U.S. Cl. 358/1.9; 358/406; 358/504; 358/3.26

(57) ABSTRACT

An image structure reproduction quality creating method comprises steps of: obtaining test image data in which an input device reads test image outputted from an output device; extracting a reproduction state of an image structure of the test image subjected to reading and outputting in accordance with the test image data; and creating an image structure reproduction quality representative of a reproduction ability of an image structure, wherein the output device outputs an image, in accordance with the reproduction state and image structure reproduction quality representative of a reproduction ability of an image structure wherein the input device reads an image and obtains image data.

### BACKGROUND OF THE INVENTION

1. Field of the Invention

The present invention relates to an image structure reproduction quality creating method of creating image structure reproduction quality representative of reproduction ability for an image structure when an output device, which outputs an image in accordance with image data, outputs an image, an image structure reproduction quality creating apparatus, and an image structure reproduction quality creating program storage medium storing an image structure reproduction quality creating program, when executed in a computer, which causes the computer to operate as the image structure reproduction quality creating apparatus.

2. Description of the Related Art

There is adopted for various uses an image reproduction system in which a predetermined image processing such as a tone regulation and a sharpness correction is applied to image data which is obtained through taking-in an image by an input device such as a scanner and a digital still camera, and the image data subjected to the image processing is fed to an output device such as a display and a printer so that a reproduction image is obtained. Usually, according to the image reproduction system as mentioned above, the input device for taking-in an image, an image processing apparatus for applying the predetermined image processing to the image data, and the output device for outputting the reproduction image are associated with one another on a one-to-one basis. However, recently, as computer and workstation develop, there is increased an open system associating with a plurality of types of input devices and/or output devices, for example, a system in which image data read by a scanner is subjected to image processing through a workstation, and the processed image data is fed to a printer and a CRT so that an image is reproduced, and system in which an original image is taken in by a scanner and a digital still camera, and the obtained image data are individually subjected to image processing through a workstation so that reproduction image is outputted.

According to such an open system, regardless of types of the input device and the output device, in the event that the same original image is processed, it is required that the same reproduction image is always obtained. In a printing field wherein for example DTP (Desk Top Publishing) is extremely advanced, a printing is performed in such a manner that an original is read by a scanner on a photoelectric basis, a workstation processes the original, an image recording apparatus using photosensitive materials and the like outputs an image so that the image is proofread, and a printing plate is created after completion of the proofreading. Accordingly, it is requested that an image reproduced in proof is preferably coincident with a printed image. Further, even if a reading unit for an original and an image recording apparatus for outputting a proof are changed, it is required that the same proof is always outputted.

However, regardless of the printing field, it is usual that properties of input device and output device are varied for each type of the devices. In the open system for processing a plurality of types of input devices and output devices, it is associated with a problem that even if the same original image is used to reproduce an image, color and density of the reproduction image, and the image structure would be varied depending on the input devices and the output devices.

In order to resolve this problem, ICC (International Color Consortium) proposes a method of ICC Profile Format Specification. According to this method, for example, in case of image data of red (R), green (G) and blue (B), there are provided, as a profile, a conversion table for converting image data of R, G and B into XYZ color system of CIE (Commission International de I'Eclairage) and 3×3 matrix. The image data of R, G and B taken-in by the input device is processed with the profile to obtain the image data of the XYZ color system. According to the method of ICC Profile Format Specification, it is intended to obtain the same images from an original image independent of properties of input devices and output devices in such a manner that various sorts of image processing are applied in the XYZ color system, so that the image data of the XYZ color system is converted into image data (for example, image data of R, G and B, and image data of C, M and Y) associated with the output device.

The use of the method proposed by ICC as mentioned above makes it possible for the open system to obtain images of the same color and density from the same original image independent of sorts of input devices and output devices. However, even if such a method is used, an image structure of the sharpness and the like would vary in accordance with sorts of input devices and output devices, and in the event that a device is varied in the open system, it would be difficult to always obtain an image that is the same in image structure from an original image. For this reason, with respect to the image structure of the reproduction image, it is obliged that processing is made in accordance with an operator's feeling.

In view of the foregoing, there are proposed technologies in which reproduction quality representative of reproduction property of the image structure in input devices and output devices is used to perform image processing (for example, TokuKai Hei. 10-51641, TokuKai Hei. 10-79023, and TokuKai Hei. 11-98364).

However, hitherto there is no proposal as to a method of suitably creating reproduction quality of an image structure for particularly output devices, and thus it is difficult to actually execute a suitable image processing.

### SUMMARY OF THE INVENTION

In view of the foregoing, it is an object of the present invention to provide an image structure reproduction quality creating method capable of suitably creating reproduction quality of an image structure for particularly output devices, an image structure reproduction quality creating apparatus, and an image structure reproduction quality creating program storage medium storing an image structure reproduction quality creating program, when executed in a computer, which causes the computer to operate as the image structure reproduction quality creating apparatus.

To achieve the above-mentioned object, the present invention provides an image structure reproduction quality creating method comprising:
an image data obtaining step of obtaining test image data in which a predetermined input device for reading an image to obtain image data reads test image outputted from an output device for outputting an image in accordance with image data;
an extraction step of extracting a reproduction state of an image structure of the test image subjected to reading and outputting in accordance with the test image data obtained in the image data obtaining step; and
a characteristic creating step of creating an image structure reproduction quality representative of a reproduction ability of an image structure, wherein the output device outputs an image, in accordance with the reproduction state extracted in the extraction step and image structure reproduction quality representative of a reproduction ability of an image structure wherein the input device reads an image and obtains image data.

With respect to an image structure reproduction quality of an input device, there is considered a method of creating the image structure reproduction quality in such a manner that image data obtained through reading a suitable test image is analyzed. Thus, according to the image structure reproduction quality creating method, the image structure reproduction quality of the output device is determined in such a manner that the test image outputted from the output device is read using the input device which is known in the image structure reproduction quality. This feature makes it possible to obtain the suitable image structure reproduction quality on the output device.

In the image structure reproduction quality creating method according to the present invention as mentioned above, it is preferable that the image structure reproduction quality creating method further comprises an image outputting step of inputting image data for outputting the test image into the output device and causing the output device to output the test image, and
the extraction step extracts the a reproduction state in accordance with characteristics of the image data created in the image outputting step.

This feature makes it possible to suitably and readily extract the reproduction state of the image structure.

To achieve the above-mentioned object, the present invention provides an image structure reproduction quality creating apparatus comprising:
an image data obtaining section that obtains test image data in which a predetermined input device for reading an image to obtain image data reads test image outputted from an output device for outputting an image in accordance with image data;
an extraction section that extracts a reproduction state of an image structure of the test image subjected to reading and outputting in accordance with the test image data obtained in the image data obtaining section; and
a characteristic creating section that creates an image structure reproduction quality representative of a reproduction ability of an image structure, wherein the output device outputs an image, in accordance with the reproduction state extracted in the extraction section and image structure reproduction quality representative of a reproduction ability of an image structure wherein the input device reads an image and obtains image data.

To achieve the above-mentioned object, the present invention provides an image structure reproduction quality creating program storage medium storing an image structure reproduction quality creating program which causes a computer to operate as an image structure reproduction quality creating apparatus, when the image structure reproduction quality creating program is executed in the computer, wherein the image structure reproduction quality creating program storage medium stores the image structure reproduction quality creating program comprising:
an image data obtaining section that obtains test image data in which a predetermined input device for reading an image to obtain image data reads test image outputted from an output device for outputting an image in accordance with image data;
an extraction section that extracts a reproduction state of an image structure of the test image subjected to reading and outputting in accordance with the test image data obtained in the image data obtaining section; and
a characteristic creating section that creates an image structure reproduction quality representative of a reproduction ability of an image structure, wherein the output device outputs an image, in accordance with the reproduction state extracted in the extraction section and image structure reproduction quality representative of a reproduction ability of an image structure wherein the input device reads an image and obtains image data.

With respect to the image structure reproduction quality creating program storage medium of the present invention and the structure reproduction quality creating apparatus of the present invention, only the basic aspects are disclosed here. It is noted that the image structure reproduction quality creating program storage medium of the present invention and the structure reproduction quality creating apparatus of the present invention include not only the basic aspects, but also various aspects corresponding to the above-mentioned aspects of the image structure reproduction quality creating program storage medium of the present invention.

While the similar names are applied to the structural elements in the image structure reproduction quality creating program storage medium of the present invention and the structure reproduction quality creating apparatus of the present invention, those structural elements mean the hardware and the software in the image the structure reproduction quality creating apparatus, and mean only the software in the image structure reproduction quality creating program storage medium.

With respect to the structural elements such as the profile obtaining section constituting the image structure reproduction quality creating program storage medium of the present invention related to the present invention, it is acceptable that function of one structural element is implemented by one program part, function of one structural element is implemented by a plurality of program parts, or alternatively functions of a plurality structural elements are implemented by one program part. Further, it is acceptable that those structural elements are executed by oneself or by instruction to another program or program parts incorporated into a computer.

### BRIEF DESCRIPTION OF THE DRAWINGS

FIG. 1 is a schematic constitution view of an image reading and printing system to which an embodiment of the present invention is applied.

FIG. 2 is a perspective view of a computer.

FIG. 3 is a flowchart useful for understanding an embodiment of an image structure reproduction quality creating method of the present invention.

FIG. 4 is a conceptual view showing storage medium storing an image structure reproduction quality creating program, as an embodiment of an image structure reproduction quality creating program storage medium according to the present invention.

FIG. 5 is a functional block diagram of an image structure reproduction quality creating apparatus according to an embodiment of the present invention, as shown in FIG. 1.

FIG. 6 is an enlargement view of a first test pattern.

FIG. 7 is an enlargement view of a second test pattern.

FIG. 8 is a graph showing an example of response values G(fi).

FIG. 9 is a graph showing an example of response values H_{IN}(fi) of MTF characteristics corresponding to an image structure reproduction quality of a color scanner.

FIG. 10 is a functional block diagram of an image processing apparatus.

FIG. 11 is an explanatory view useful for understanding a parameter determination processing.

### DETAILED DESCRIPTION OF PREFERRED EMBODIMENTS

Embodiments of the present invention will be described with reference to the accompanying drawings.

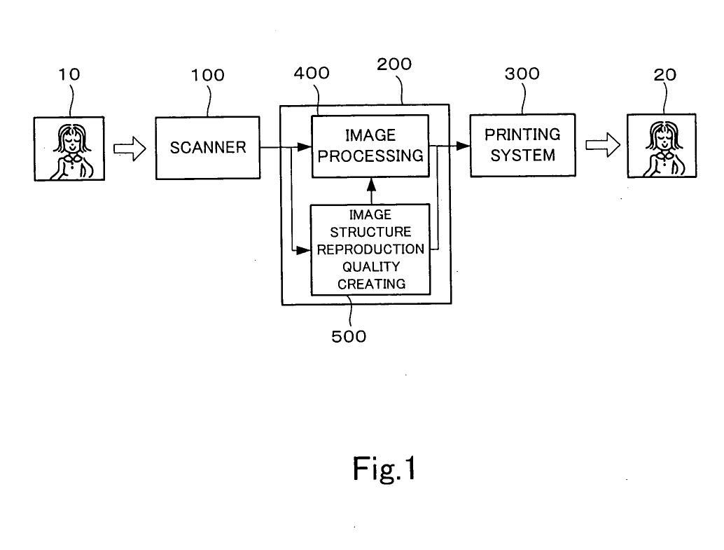

FIG. 1 is a schematic constitution view of an image reading and printing system to which an embodiment of the present invention is applied.

A color scanner 100 reads an original image 10 and produces color separation image data for three colors of C, M, and Y, in which the original image 10 thus read is represented in form of a set of pixels having tone values of CMY. The image data of CMY produced by the color scanner 100 is fed to a computer 200, into which both the function as an image processing apparatus 400 and the function as an image structure reproduction quality creating apparatus 500 are incorporated. In the computer 200, an operator performs an electronic page make-up in accordance with entered image data, so that image data for printing is created. Here, the electronic page make-up temporarily creates image data in form of description language data described in a so-called PDL (Page Description Language), and the image data is developed by a so-called RIP (Raster Image Processor) into a bit map and is converted into image data for printing for CMYK four colors in which tone values are applied to bits (pixels).

The image data for printing is fed to a film printer of a printing system 300, which corresponds to an example of an output device referred to in the present invention. The film printer creates film original plates for printing for plates for CMYK in accordance with the received image data. A machine plate is created from the film original plates for printing. The machine plate thus created is mounted on a printing machine of the printing system 300. Ink is applied to the machine plate mounted on the printing machine, and the applied ink is transferred to a sheet for printing so that a printed image 20 is formed on the sheet.

An aspect as an embodiment of the present invention in the image reading and printing system shown in FIG. 1 resides in function as the image structure reproduction quality creating apparatus 500 incorporated into the computer 200. Hereinafter, there will be described the computer 20 and the image structure reproduction quality creating apparatus 500.

Here, first, there will be described a hardware structure of the computer 200.

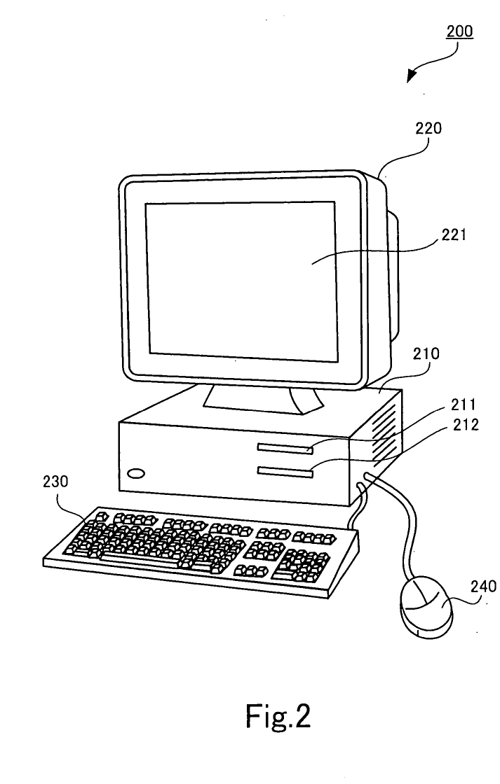

FIG. 2 is a perspective view of the computer 200 shown in FIG. 1.

The computer 200 comprises, on an external appearance, a main frame unit 210 incorporating thereinto CPU, a RAM memory, a hard disk and the like, a CRT display unit 220 for displaying an image on a fluorescence screen 221 in accordance with an instruction from the main frame unit 210, a keyboard 230 for inputting various sorts of information, such as user's instruction and character information, to the computer system in accordance with a key operation, and a mouse 24 for inputting an instruction according to, for example, an icon and the like, through designation of an optional position on the fluorescence screen 221, the icon and the like being displayed on the position on the fluorescence screen 221.

The main frame unit 210 has, on an external appearance, a flexible disk mounting slot 211 for mounting a flexible disk (FD), and a CD-ROM mounting slot 212 for mounting a CD-ROM. The main frame unit 21 has, inside, a flexible disk (FD) disk drive for driving the flexible disk, and a CD-ROM drive for driving the CD-ROM.

The CD-ROM stores therein an image structure reproduction quality creating program for causing the computer 200 to operate as an image structure reproduction quality creating apparatus of the present invention. The CD-ROM is mounted on the CD-ROM drive so that the image structure reproduction quality creating program, which is stored in the CD-ROM, is up-loaded on the computer 200 and is stored in the hard disk unit. When the image structure reproduction quality creating program is executed, the computer 200 serves as an image structure reproduction quality creating apparatus according to an embodiment of the present invention, and executes an embodiment of an image structure reproduction quality creating method referred to in the present invention.

As a storage medium for storing the image structure reproduction quality creating program referred to in the present invention, it is acceptable to adopt not only the above-mentioned CD-ROM and hard disk, but also various sorts of storage medium such as a flexible disk, a DVD and MO.

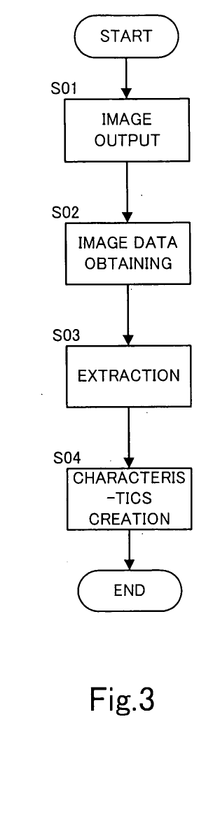

FIG. 3 is a flowchart useful for understanding an embodiment of an image structure reproduction quality creating method of the present invention.

The image structure reproduction quality creating method is executed by the image structure reproduction quality creating apparatus 500 of the computer 200 shown in FIG. 1. The image structure reproduction quality creating method according to the present embodiment comprises an image output step (step S01), an image data obtaining step (step S02), an extraction step (step S03), and a quality creating step (step S04).

Details of those steps will be described later.

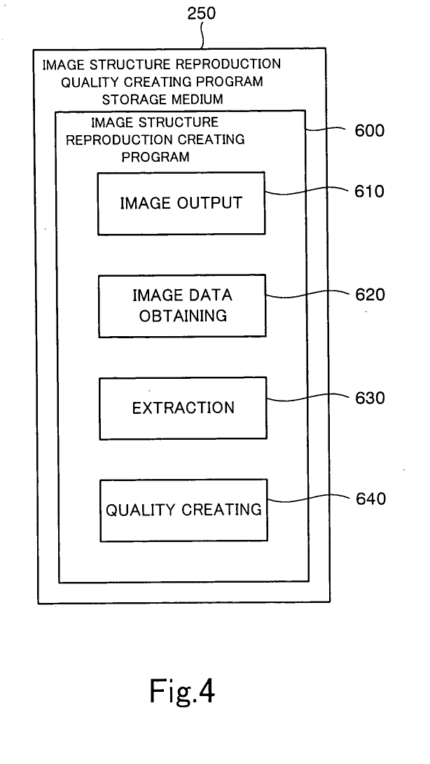

FIG. 4 is a conceptual view showing storage medium storing an image structure reproduction quality creating program, as an embodiment of an image structure reproduction quality creating program storage medium according to the present invention. An image structure reproduction quality creating program 600 is stored in a CD-ROM 250.

The image structure reproduction quality creating program 600 is executed in the computer 200 shown in FIG. 2, and causes the computer 200 to operate as the image structure reproduction quality creating apparatus 500 shown in FIG. 1, so as to execute the image structure reproduction quality creating method shown in FIG. 3. The image structure reproduction quality creating program 600 comprises an image output section 610, an image data obtaining section 620, an extraction section 630 and a quality creating section 640.

Functions of the elements of the image structure reproduction quality creating program 600 will be described later.

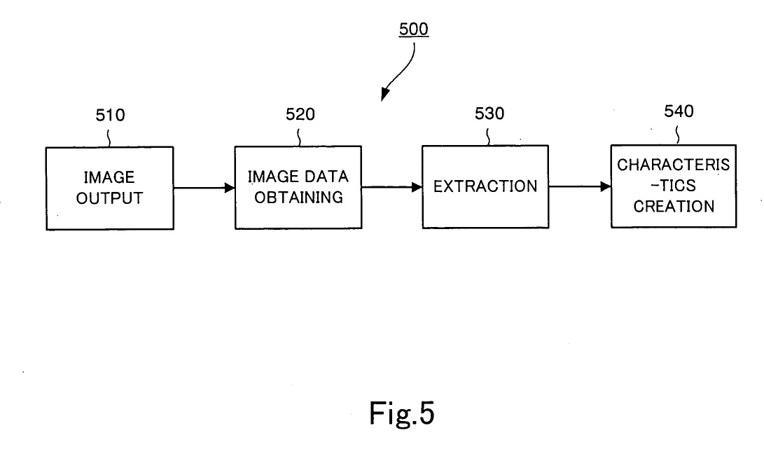

FIG. 5 is a functional block diagram of an image structure reproduction quality creating apparatus 500 according to an embodiment of the present invention, as shown in FIG. 1.

The image structure reproduction quality creating apparatus 500 is implemented when the image structure reproduction quality creating program 600 shown in FIG. 4 is installed in the computer and is executed by the computer.

The image structure reproduction quality creating apparatus 500 comprises an image output section 510, an image data obtaining section 520, an extraction section 530 and a quality creating section 540, which correspond to the image output section 610, the image data obtaining section 620, the extraction section 630 and the quality creating section 640 of the image structure reproduction quality creating program 600 shown in FIG. 4, respectively. The similar names are applied to the structural elements in the image structure reproduction quality creating apparatus 500 shown in FIG. 5 and the image structure reproduction quality creating program 600 shown in FIG. 4, those structural elements mean the hardware of the computer shown in FIG. 2 and the software, such as OS to be executed by the computer, and computer parts, in the image structure reproduction quality creating apparatus 500, and mean only the software in the image structure reproduction quality creating program 600 shown in FIG. 4.

Hereinafter, there will be explained the respective elements of the image structure reproduction quality creating apparatus 500 shown in FIG. 5, so that there will be explained the respective steps of the image structure reproduction quality creating method shown in FIG. 3, and the respective elements of the image structure reproduction quality creating program 600 shown in FIG. 4.

The image output section 510 creates image data representative of an test image, which will be described hereinafter, and feeds the image data to the printing system 300 shown in FIG. 1, so that the printing system 300 prints the text image. According to the present embodiment, as the text image, there is used a test pattern consisting of shading stripes of grey (C=M=Y) having a predetermined spatial frequency, wherein there exist two sorts of test patterns mutually crossing at right angles in a direction of the strips.

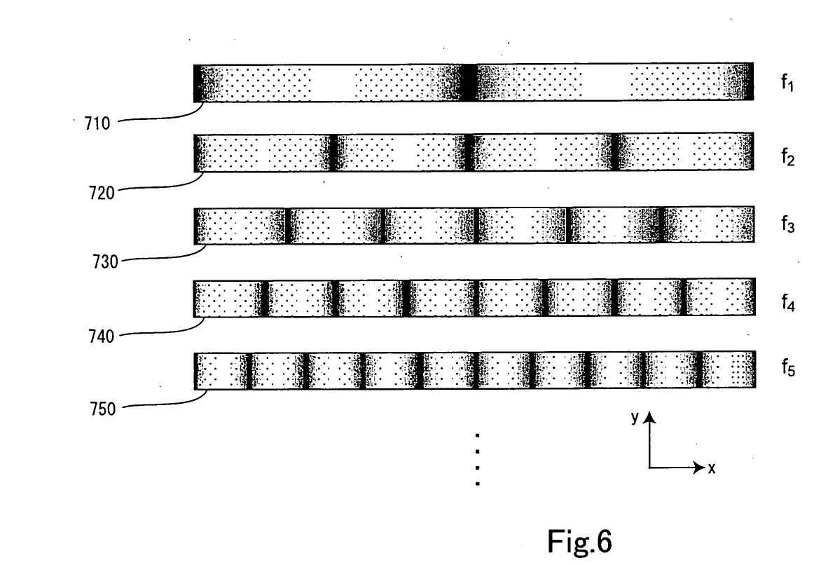

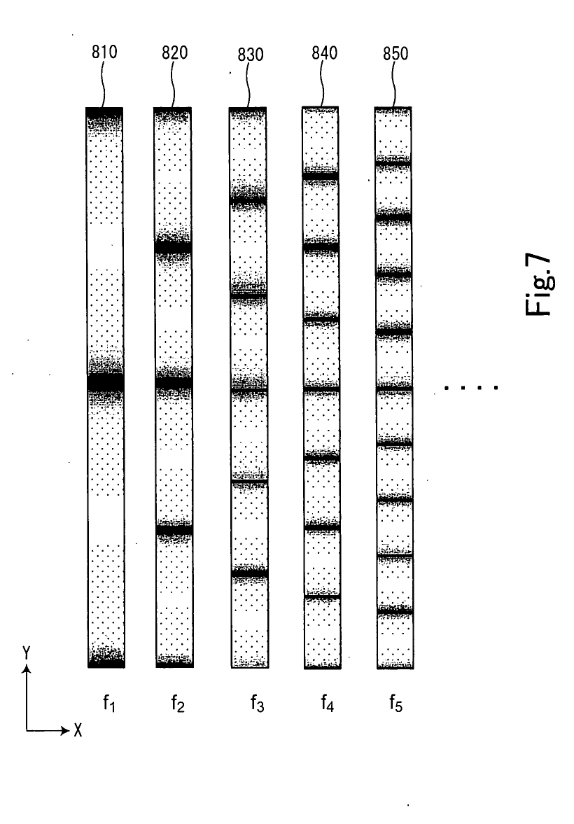

FIG. 6 is an enlargement view of a first test pattern. FIG. 7 is an enlargement view of a second test pattern.

In FIG. 6 and FIG. 7, there is shown a common x-y coordinates axes. According to the first test pattern, there is arranged in y-direction a plurality of shading stripes 710, 720, 730, 740, 750, . . . , varying in shading in x-direction as to a plurality of spatial frequencies f1, f2, f3, f4, f5, . . . . According to the second test pattern, there is arranged in x-direction a plurality of shading stripes 810, 820, 830, 840, 850, . . . , varying in shading in y-direction as to a plurality of spatial frequencies f1, f2, f3, f4, f5, . . . . According to the present embodiment, those shading stripes are formed with halftone dots, and image data representative of the test pattern represents a sine wave-like shaped shading variation, which is common in amplitude in the shading stripes. Further, the spatial frequency fi (i=1, 2, . . . , n), which is set fort below, is applied to the respective shading stripes.
fi=2i (cycle/degree)

The shading stripes 710, . . . , 750, . . . , which are shown in FIG. 6, and the shading stripes 810, . . . , 850, . . . , which are shown in FIG. 7, correspond to a degree of stripes. Where degree denotes a view angle and the actual length d corresponding to 1 degree depends on the observation distance D (mm), that is,
D=2D tan (π/360)
According to the present embodiment, as the observation distance D, 300 mm is adopted, and the test pattern is outputted where d=5.236 (mm). Accordingly, the actual length of the shading stripes 710, . . . , 750, . . . , which are shown in FIG. 6, and the shading stripes 810, . . . , 850, . . . , which are shown in FIG. 7, is expressed by d=5.236 (mm). Incidentally, as to the upper limit fn of the spatial frequency, the value is selected wherein no aliasing due to the dot structure occurs, and there is selected the value less than d/2 of the maximum frequency R reproducible from the sampling theory, depending on resolution R (dpmm) of the printing system 300 shown in FIG. 1 and the length d as well. Further, when there is created image data representative of a shading strip varying as a sine wave, in order to avoid a so-called quantization error wherein the corresponding one less than one bit is carried up or cut off, there is adopted a so-called error diffusion method in which random error less than a bit of error is added to a sine wave for digitalization.

According to the present embodiment, the color scanner 100 shown in FIG. 1 is utilized as an example of the input device referred to in the present invention. The color scanner 100 reads the test patterns shown in FIG. 6 and FIG. 7 to create text image data. The image data obtaining section 520 shown in FIG. 5 receives text image data from the color scanner 100 and transmits the same to the extraction section 530.

The extraction section 530 analyzes the text image data to extract the reproduction state of the respective spatial frequency components involved in the read test pattern. According to the present embodiment, as the reproduction quality of the image structure, there is adopted response values referred to MTF characteristics, which are representative of shading quality of shading amplitude in the sine wave like-shading structure, and the reproduction state is also extracted as the response values. The test pattern used in the present embodiment includes the shading stripes in the x-direction and the y-direction. However, in the following explanation, the explanation will be made taking no notice of the directions, assuming that the reproduction qualities are the same as one another in the x-direction and the y-direction.

To extract the reproduction state, first, the data for the shading stripes constructing the test patter is subjected to a fast Fourier transformation. Since the spatial frequencies fi (i=1, 2, . . . , n) applied to the respective shading stripes are known, there are obtained the response values G(fi) in the spatial frequencies fi (i=1, 2, . . . , n) applied to the respective shading stripes, from the frequency distribution obtained through the fast Fourier transformation for the shading stripes. The response value G(fi) represents the reproduction state of the shading amplitude in the sine wave shaped shading structure.

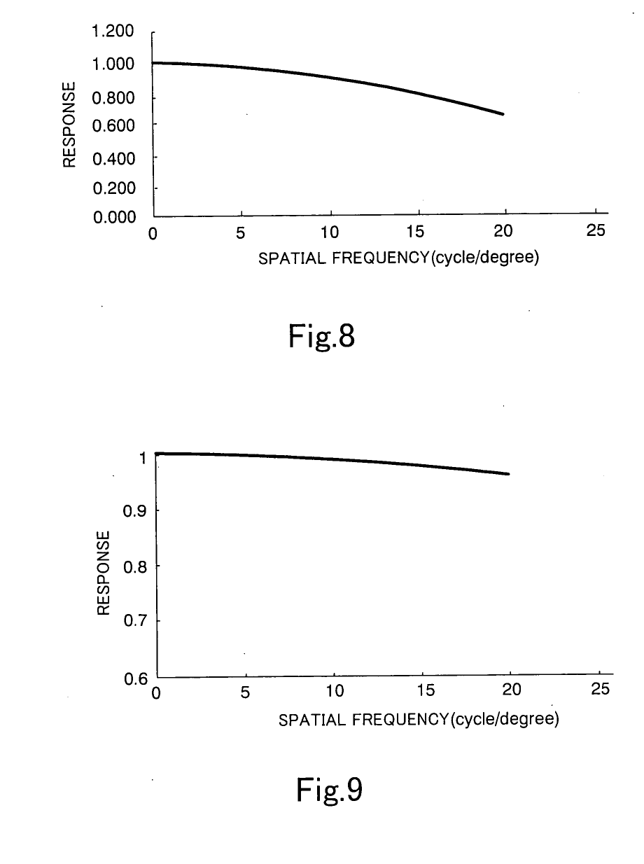

FIG. 8 is a graph showing an example of response values G(fi).

A horizontal axis of FIG. 8 denotes the spatial frequency fi, and a vertical axis denotes the response values G(fi). FIG. 8 shows a graph, which is expressed in such a manner that the extraction results of Table 1 set forth below are smoothly coupled with one another.

TABLE 1

| Spatial | |
|---|---|
| frequency | Response |
| 0 | 1.000 |
| 2 | 0.996 |
| 4 | 0.985 |
| 6 | 0.967 |
| 8 | 0.943 |
| 10 | 0.913 |
| 12 | 0.877 |
| 14 | 0.836 |
| 16 | 0.788 |
| 18 | 0.735 |
| 20 | 0.677 |

Other hand, the quality creating section 540 shown in FIG. 5 previously prepares the response values H_{IN}(fi) of MTF characteristics corresponding to the image structure reproduction quality of the color scanner utilized as an example of the input device referred to in the present invention.

FIG. 9 is a graph showing an example of response values H_{IN}(fi) of MTF characteristics corresponding to an image structure reproduction quality of a color scanner.

A horizontal axis of FIG. 9 denotes the spatial frequency fi, and a vertical axis denotes the response values H_{IN}(fi) corresponding to the image structure reproduction quality. FIG. 9 shows a graph, which is expressed in such a manner that the response values of Table 2 set forth below are smoothly coupled with one another.

TABLE 2

| Spatial | |
|---|---|
| frequency | Response |
| 0 | 1 |
| 2 | 0.999 |
| 4 | 0.998 |
| 6 | 0.996 |
| 8 | 0.993 |
| 10 | 0.990 |
| 12 | 0.985 |
| 14 | 0.980 |
| 16 | 0.974 |
| 18 | 0.968 |
| 20 | 0.960 |

The quality creating section 540 shown in FIG. 5 computes the response values H_{OUT}(fi) of MTF characteristics corresponding to an image structure reproduction quality of the printing system 300 shown in FIG. 1 in accordance with the response values G(fi) extracted by the extraction section 530 and the response values H_{IN}(fi) of the color scanner, which is previously prepared. In other words, the quality creating section 540 computes the response values H_{OUT}(fi) of MTF characteristics in accordance with the following formula.
H_{OUT}(fi)=G(fi)/H_{IN}(fi)

In case of the use of the examples shown in Table 1 and Table 2, as the response values H_{OUT}(fi) of the printing system, there is obtained the response values exemplarily shown in Table 3 set forth below.

TABLE 3

| Spatial | |
|---|---|
| frequency | Response |
| 0 | 1.000 |
| 2 | 0.996 |
| 4 | 0.986 |
| 6 | 0.971 |
| 8 | 0.949 |
| 10 | 0.923 |
| 12 | 0.890 |
| 14 | 0.852 |
| 16 | 0.809 |
| 18 | 0.759 |
| 20 | 0.705 |

The quality creating section 540 computes the function H_{OUT}(f) wherein the response thus obtained are smoothly coupled with one another, through quadratic polynomial approximation, so that the function H_{OUT}(f) as set forth below is obtained.
H_{OUT}(f)=−0.0007 f²−0.0007 f+1.0003
The function H_{OUT}(f) corresponds to the response value of the MTF characteristics to the arbitrary spatial frequency in the printing system 300 shown in FIG. 1.

Finally, there will be explained a utilizing way for the MTF characteristics thus obtained. The MTF characteristics of the printing system is utilized for image processing in the image processing apparatus 400 shown in FIG. 1 together with the MTF characteristics of the color scanner.

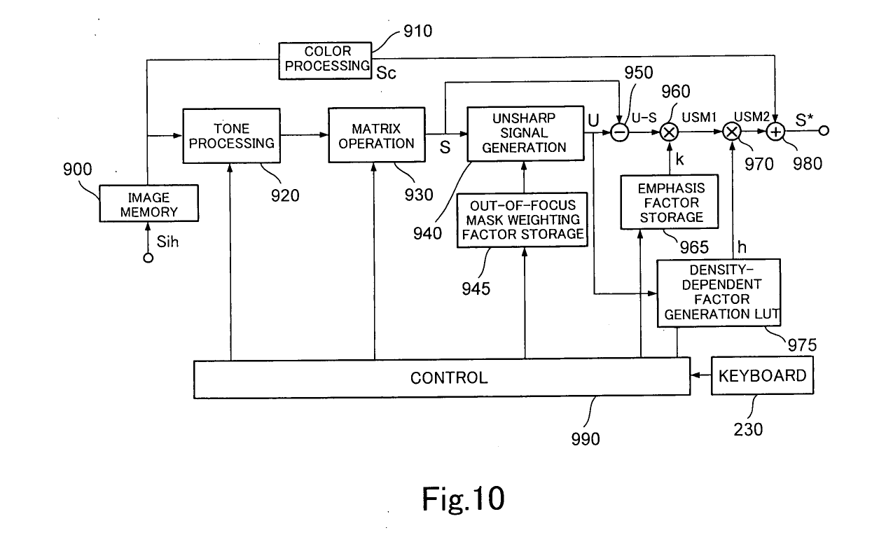

FIG. 10 is a functional block diagram of the image processing apparatus 400.

When the image processing apparatus 400 receives an image signal Sin outputted from the scanner 100, an image memory 900 temporarily stores the image signal Sin. The image signal Sin is supplied to a color processing section 910 and also to a tone processing section 920. Prior to the image processing, a control section 990 sets up various sorts of parameters to a tone processing section 920, an out-of-focus mask weighting factor storage section 945, an emphasis factor storage section 965, and a density-dependent factor generation section 975. The tone processing section 920 converts image signals of 10 bits (1024 tones) for three primary colors of R (Red), G (Green), and B (Blue), which are luminance signal, into image signals of 8 bits (256 tones) for three primary colors of C (Cyan), M (Magenta), and Y (Yellow), which are density signal, in accordance with the set Look Up Table (LUT), and then outputs those signals to a matrix operation section 930.

On the other hand, the color processing section 910 performs color processing including a three colors-four colors conversion, a color correction, and a tone conversion for the image signals of 10 bits (1024 tones) for three primary colors of R, G and B, and converts those image signals to the image signals of 8 bits for four colors of Y, M, C and K and then supplies the same to an addition section 980.

The above-mentioned matrix operation section 930 performs a matrix multiplication of 4×3 of matrix previously prepared by 3×1 of input matrix consisting of elements Y. M and C, and generates 4×1 of output matrix, in which elements are image signals of Y, M, C and K (black).

Next, an unsharp signal generating section 940 generates unsharp signals U in such a manner that image signals, which are cut out with a predetermined mask size (for example, 7 pixels×7 pixels) in the vicinity of the noticed pixels for the sharpness processing including the noticed pixels, are sequentially effected by the weighting mask set up in the weighting factors outputted from the out-of-focus mask weighting factor storage section 945, and whenever it is effected, the weighting factor is multiplied by the associated pixel and then arithmetic mean is carried out.

In the event that a desired sharpness processing is carried out, it is important that a weighting mask, in which weighting factors that are parameters set up from the control section 990 to the out-of-focus mask weighting factor storage section 945 are applied, may reproduce reference characteristics optimal empirically, which is obtained through a parameter control on a manual basis in the specified input and output form. The weighting factors are generated when the control section 990 performs a parameter determination processing which will be described later.

Next, a subtraction section 950 generates a difference signal S-U through a subtraction of the unsharp signal U from the image signal S.

Next, emphasis factor (gain) k is read from the emphasis factor storage section 965, and a multiplication section 960 multiplies the difference signal S-U by the emphasis factor (gain) k so as to create an unsharp masking signal USM1 (=k (S-U)) as the product signal. The emphasis factor k is also created by the parameter determination processing, which will be described later.

A multiplication section 970 multiplies a density-dependent factor h according to a magnitude of the unsharp signal U, which is outputted from the look up table (LUT) of the density-dependent factor generation section 975, by the unsharp masking signal USM1 to generate an unsharp masking signal USM2 (=h·k(S-U)) varied in amplitude.

In the addition section 980, the unsharp masking signal USM2 is added to an image signal Sc, which is subjected to the color processing in the color processing section 910, so that an image signal S* after the sharpness emphasis processing, as shown in the formula set forth below, is created.
S*=Sc+USM2=Sc+h·USM1=Sc+h·k(S-U)

Here, there will be explained the parameter determination processing to be executed in the control section 990.

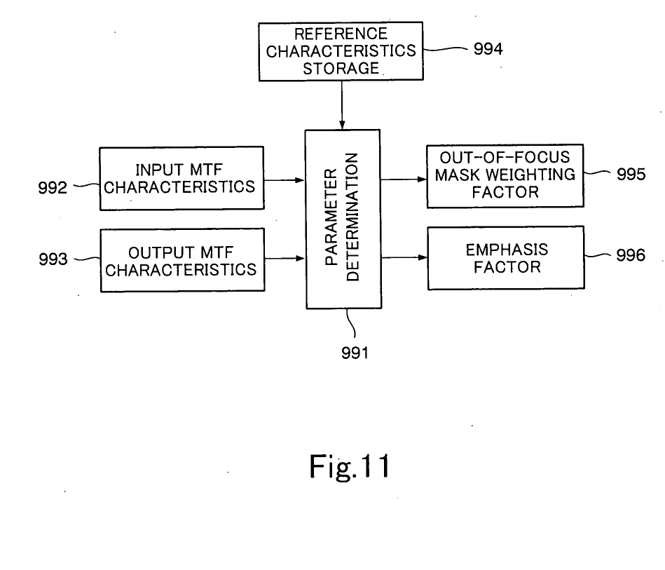

FIG. 11 is an explanatory view useful for understanding a parameter determination processing.

A parameter determination processing section 991 computes an out-of-focus mask weighting factor 995 and an emphasis factor 996 in such a manner that reference characteristics, which are prepared in a reference characteristics storage section 994, are reproduced in accordance with input MTF characteristics 992 representative of reproduction quality of the image structure in a color scanner used for reading an original image of processing object, and output MTF characteristics 993 representative of reproduction quality of the image structure in the printing system 300 as shown in FIG. 1 created as mentioned above. That is, the frequency emphasis characteristic H_{IP} in a desired sharpness processing to be applied by the image processing is expressed by the following formula.
H_{IP}(f)=Hs(f)/{H_{IN}(f)×H_{OUT}(f)}
where Hs(f) denotes reference characteristic, and H_{IN}(f) and H_{OUT}(f) denote the input MTF characteristics 992 and the output MTF characteristics 993, respectively. And the out-of-focus mask weighting factor 995 and the emphasis factor 996 are determined in such a manner that the frequency emphasis characteristic H_{IP}(f) is reproduced in a suitable frequency range, such as 0≦f≦20, in accordance with the following formula, where Hu(f) denotes a frequency response characteristic to for example 7×7 pixels corresponding of out-of-focus mask weighting factor, and k denotes emphasis factor.
   H_{IP}(f)≈1+kx(1−Hu(f))
   The out-of-focus mask weighting factor 995 and the emphasis factor 996 thus determined are stored in the out-of-focus mask weighting factor storage section 945 and the emphasis factor storage section 965 through the operation of the keyboard 230 shown in FIG. 10, so that a desired sharpness processing is implemented.

Thus, according to the present embodiment of the invention, it is possible to suitably create a reproduction quality of an image structure on an output device, and thus it is possible to apply a suitable sharpness processing to an image in accordance with the reproduction quality.

Incidentally, according to the above explanation, there is disclosed the embodiment in which the color processing and the sharpness processing are carried out on a parallel basis. However, according to the present invention, it is acceptable that the color processing and the sharpness processing are carried out on a serial basis.

Further, according to the above explanation, there is disclosed the embodiment in which as an example of the image structure reproduction quality referred to in the present invention, there is shown the MTF characteristics. It is acceptable, however, that the image structure reproduction quality referred to in the present invention is characteristics representative of reproduction quality for a rectangular shaped shading structure. In this case, as the test image referred to in the present invention, there is used a shading pattern which is binarized to “light” and “shade”.

Furthermore, according to the above explanation, there is disclosed the embodiment in which the image structure reproduction quality is equal in the x-direction and the y-direction. However, it is acceptable that the image structure reproduction quality is different in the x-direction and the y-direction.

Still further, according to the above explanation, there is disclosed the embodiment in which as an example of the input device referred to in the present invention, a color scanner is used. However, it is acceptable that the input device referred to in the present invention is a digital camera.

Still furthermore, according to the above explanation, there is disclosed the embodiment in which as an example of the output device referred to in the present invention, a printing system is used. However, it is acceptable that the output device referred to in the present invention is a printer, a proofer or a display unit.

As mentioned above, according to the present invention, it is possible to suitably create an image structure reproduction quality on an output device.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

1. An image structure reproduction quality creating method comprising:
an image data obtaining step of obtaining test image data in which a predetermined input device for reading an image to obtain image data reads test image outputted from an output device for outputting an image in accordance with image data;
an extraction step of extracting a reproduction state of an image structure of the test image subjected to reading and outputting in accordance with the test image data obtained in the image data obtaining step; and
a characteristic creating step of creating an image structure reproduction quality representative of a reproduction ability of an image structure, wherein the output device outputs an image, in accordance with the reproduction state extracted in the extraction step and image structure reproduction quality representative of a reproduction ability of an image structure wherein the input device reads an image and obtains image data.

2. An image structure reproduction quality creating method according to claim 1, wherein the image structure reproduction quality creating method further comprises an image outputting step of inputting image data for outputting the test image into the output device and causing the output device to output the test image, and
the extraction step extracts the a reproduction state in accordance with characteristics of the image data created in the image outputting step.

3. An image structure reproduction quality creating apparatus comprising:
an image data obtaining section that obtains test image data in which a predetermined input device for reading an image to obtain image data reads test image outputted from an output device for outputting an image in accordance with image data;
an extraction section that extracts a reproduction state of an image structure of the test image subjected to reading and outputting in accordance with the test image data obtained in the image data obtaining section; and
a characteristic creating section that creates an image structure reproduction quality representative of a reproduction ability of an image structure, wherein the output device outputs an image, in accordance with the reproduction state extracted in the extraction section and image structure reproduction quality representative of a reproduction ability of an image structure wherein the input device reads an image and obtains image data.

4. An image structure reproduction quality creating program storage medium storing an image structure reproduction quality creating program which causes a computer to operate as an image structure reproduction quality creating apparatus, when the image structure reproduction quality creating program is executed in the computer, wherein the image structure reproduction quality creating program storage medium stores the image structure reproduction quality creating program comprising:
an image data obtaining section that obtains test image data in which a predetermined input device for reading an image to obtain image data reads test image outputted from an output device for outputting an image in accordance with image data;
an extraction section that extracts a reproduction state of an image structure of the test image subjected to reading and outputting in accordance with the test image data obtained in the image data obtaining section; and
a characteristic creating section that creates an image structure reproduction quality representative of a reproduction ability of an image structure, wherein the output device outputs an image, in accordance with the reproduction state extracted in the extraction section and image structure reproduction quality representative of a reproduction ability of an image structure wherein the input device reads an image and obtains image data.
